(19) United States
(12) Patent Application Publication
(10) Pub. No.: US 2006/0235874 A1
(43) Pub. Date: Oct. 19, 2006

(54) Method of processing a publishable document

(76) Inventors: John William Lumley, Bristol (GB); Roger Brian Gimson, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/400,991

(22) Filed: Apr. 10, 2006

(30) Foreign Application Priority Data
Apr. 13, 2005 (GB) 0507433.1

(51) Int. Cl. G06F 7/00

(52) U.S. Cl. 707/103 R

(57) ABSTRACT

A method of processing a publishable document including input program elements for processing variable data comprises compiling the publishable document into a program executable to generate a document product. The step of compiling includes identifying, for inclusion in a program, output program elements required to process variable data.

### FIELD OF THE INVENTION

The invention relates to a method of processing a publishable document.

### BACKGROUND OF THE INVENTION

Various known ways exist for processing publishable documents, that is, machine readable representations processable to provide a document product. One such publishable document comprises a proto-document or template including “copy holes” for introduction of variable data (for example a recipient address in a mail-shot), termed macro locations. The publishable document is processed by an interpreter, the macro locations being identified as substitution points and variable values such as text strings (for example the recipient address) or images inserted at the substitution points to create the document product.

### BRIEF SUMMARY OF THE INVENTION

A method of processing a publishable document including input program elements for processing variable data comprises compiling the publishable document into a program executable to generate a document product. The compiling step includes identifying, for inclusion in the program, output program elements required to process variable data.

### BRIEF DESCRIPTION OF THE DRAWINGS

Embodiments of the invention will now be described, by way of example only, with reference to the drawings, of which:

FIG. 1 is a schematic process diagram showing interaction of the components of the method described herein;

FIG. 2 is a schematic illustration of a presentation of a document product;

FIG. 3 is a flow diagram showing the steps according to the method described herein;

FIG. 4 is a flow diagram showing the steps performed according to the method described herein in a partial instantiation implementation; and

FIG. 5 is a block diagram of an apparatus configured to implement the method.

### DETAILED DESCRIPTION OF THE INVENTION

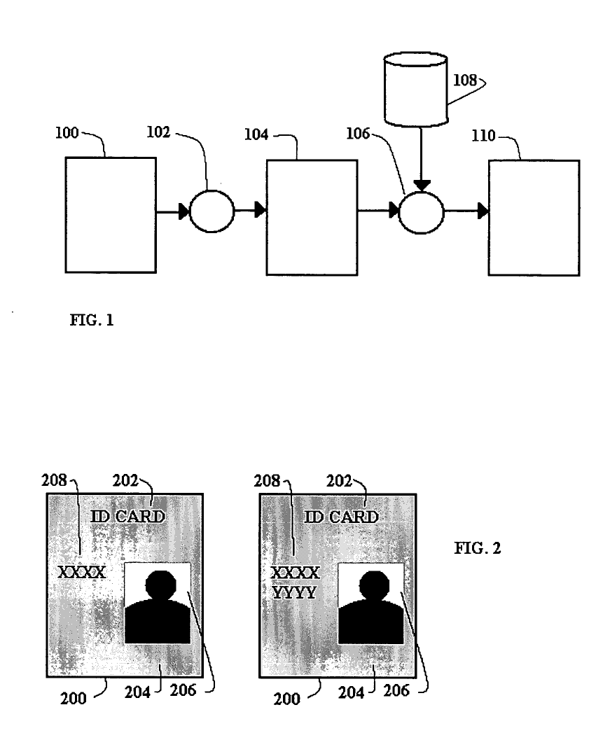

In overview the method and apparatus described herein can be understood with reference to FIG. 1 which shows the process applied to a machine readable document, that is, semantic content contained within machine readable labels which, when executed by a machine such as a computer, will result in a presentation (for example a leaflet, brochure and so forth) whose appearance is dependent upon the semantic content. References herein to “documents” therefore relate to such machine readable documents unless the context requires otherwise.

A publishable document 100, comprising a machine readable document in machine readable form such as hypertext markup language (html) or extensible markup language (xml) is provided requiring variable data processing to create a further machine readable document in the form of a resulting document product 110 incorporating the variable data. Execution of the document product 110 will result in a presentation including the additional variable data. In particular the publishable document 100 includes static content together with input program elements, where the program elements will operate on subsequently provided variable data to produce the document product including both the static content and appropriately processed variable data.

The nature of the publishable document can further be understood with reference to FIG. 2, showing the final presentation of a document product 110 produced from a publishable document 100 in two forms dependent on variable data. The embodiment shown relates to an identity card although, of course, any appropriate publishable document can be adopted. Referring firstly to identity card 200 in FIG. 2 it will be seen that this includes a title “ID card”, 202, a background (for example for security purposes) 204, an image of the ID card holder 206 and text data (such as the card holder's name “xxxx”), 208. Accordingly the title “ID card” 202 and the background 204 comprise static content, and the image data 206 and text data 208 comprise variable data.

In order to produce the document product 110 the publishable document 100 is compiled at a compiler 102 to provide a compiled document generator 104 in the form of a functional program. The compiler 102 inserts into the functional program 104 output program elements generated or constructed from the input program elements. The functional program 104 is interpreted or “evaluated” at interpreter 106 and bound with variable data 108 at the interpreter to produce the document product 110.

In the context of FIG. 2, therefore, the original publishable documents included the title 202 and background 204 as static data together with input program elements determining how to handle variable data such as image data 206 and text data 208. The document is compiled into a program which is interpreted and bound with the image and text data in a manner determined by the output program elements to provide the document product which can then be rendered to provide the actual physical representation 200 shown in FIG. 2.

In particular the compiler 102 modifies the input program elements to ensure that they can accommodate variable data and unbound data when interpreted subsequently at runtime. This modification may be conditional upon information available at the compiler concerning the possible bindings at runtime in which case selective code can be generated during the modification. Hence the compiler 102 compiles output program elements whose processing at the interpreter 106 provides a result conditional upon the variable data such that if the variable data binds to an output program element, i.e. is processable by the output program element, then this is processed to provide the final document product. Conversely if an output program element is unbound or only partially bound then at the interpreting stage the program element can be kept or modified or additional appropriate program elements can be added or generated and such unfulfilled program fragments propagated as intermediate program elements into the document product.

Accordingly, with reference to identity card 200 in FIG. 2, where for example the name data 208 is available for binding but the image data 206 is not available for binding then a document product 110 will be produced which can be executed to generate an identity card with the name data 208 but no image 206. However unfulfilled program fragments corresponding to generation of the image remain in the document product such that, when image data subsequently becomes available, the document product can be executed once again to provide an identity card representation 200 including both the name data 208 and the image data 206 as shown in FIG. 2.

As a result the publishable document is transformed into a program that will generate the resulting document product and which will pass program elements through into the document product so that it can be separately or subsequently executed as a fresh publishable document for example in the context of additional bound data when the variable data is updated. This allows delayed processing steps, for example viewing of a document at an intermediate stage when the variable data is not fully instantiated (for example no image data in FIG. 2), or partial evaluation where some program part is not bound yet, permitting incremental or repeat binding. This can be contrasted, for example, with proto-documents including macro locations which, once interpreted, contain no program parts such that if the variable data is updated, the proto-document has to be recreated from scratch.

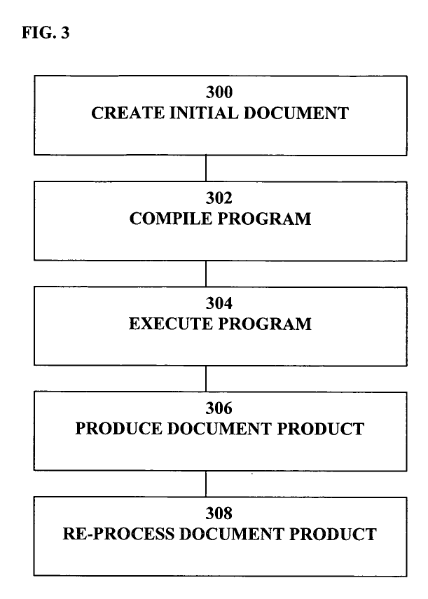

Referring to FIG. 3, the method described herein is shown in more detail. In step 300 the initial document is created. The document effectively comprises a series of programmatic elements that define the linkage between various segments of the document and its data. An example of such a document is shown below in listing 1, expressed in xml:

| | |
|---|---|
| <doc> | |
| <data> | |
| static data pieces | |
| <reference to variable data/> | |
| </data> | (listing 1) |
| <structure> | |
| static structural pieces | |
| <program: data->extra structure/> | |
| </structure> | |
| <presentation> | |
| static presentation | |
| <program: structure->extra presentation/> | |
| static presentation | |
| </presentation> | |
| </doc> | |

It will be seen that the document comprises data, structure and presentation components or sections. The data component comprise static content, i.e. static data pieces together with variable data at an external location identified by an appropriate reference, such as data corresponding to the image 206 and name 208 in FIG. 2.

The structure component comprises logical document structure allowing, for example the nature of the data to be bound to be dependent upon a further parameter. In the case of the identity card discussed above with reference to FIG. 2, for a first class of identity card holders the variable data at 208 may simply comprise the card holder's name. However in relation to a second class of card holders the data 208 may comprise both name information for the card holder and also data information such as status (e.g. “Very Important Person”).

The presentation component comprises visible presentational information such as the title “ID card” 202 and the background 204 in FIG. 2. In addition the structure and presentation components include program components in the form of input program elements linking through to the other components in the document.

At step 302 the publishable document is compiled to convert it, through a series of rigorous transformation steps, into an executable computer program of the type shown below:

| | |
|---|---|
| <program: | |
| <doc> | |
| <data> | |
| static data pieces | |
| get(<reference to variable data/>) | |
| </data> | |
| <structure> | |
| static structural pieces | |
| data->extra structure( | |
| static data pieces | |
| get(<reference to variable data/>) | |
| ) | |
| </structure> | |
| <presentation> | |
| static presentation | |
| structure->extra presentation( | |
| static structural pieces | |
| data->extra structure( | (listing 2) |
| static data pieces | |
| get(<reference to variable data/>) | |
| ) | |
| ) | |
| static presentation | |
| </presentation> | |
| </doc> | |
| </program> | |

It will be seen that the components are retained separately and that output program elements are expressed separately. Although listing 2 is expressed in an extended form for clarity of understanding the listing can of course be optimised with respect to common sub expressions if appropriate.

At step 304 the program is executed which produces the resultant document product at step 306. The document product can be expressed as shown in listing 3 below:

| | |
|---|---|
| <program: | |
| <doc> | |
| <data> | |
| static data pieces | |
| get(<reference to bound variable data/>) | |
| program: get(<reference to variable data/>) | |
| </data> | |
| <structure> | |
| static structural pieces | |
| data->extra structure( | |
| static data pieces | |
| get(<reference to bound variable data/>) | |
| ) | |
| <program: new data->extra structure/> | |
| </structure> | |
| <presentation> | |
| static presentation | |
| structure->extra presentation( | |
| static structural pieces | |
| data->extra structure( | (listing 3) |
| static data pieces | |
| get(<reference to bound variable data/>) | |
| ) | |
| ) | |
| <program: new structure->extra presentation/> | |
| static presentation | |
| </presentation> | |
| </doc> | |
| </program> | |

Accordingly the output of the program, when run with instances of all or part of the variable data as input, produces the resulting document with all provided variable data interpolated and combined correctly, and suitable program components placed for correct processing of other variable data bound at a subsequent time. Accordingly the effects are fully propagated as far as the semantics of the programmatic elements are concerned.

During the transformation process, other ancillary information can be added as necessary. For example auditing trails can provide information such as the source of variable data, external context and so forth in addition to the propagation of continuations for unbound input. The ancillary information can be added statically into the resulting document product or can be installed at the compiler as extra program components that will write the appropriate information at runtime. Furthermore the compiler can install output program elements capable of recognising and extracting variable data from a variable data input even where the variable data is not in a data space.

It will be seen that during execution of the program at the interpreter, the program can dynamically discover unbound data or can recognise it from explicit instructions installed at the compilation stage. In addition null data and no data can be effectively distinguished such that the unfulfilled program elements propagate appropriately. Accordingly the variable data input at the interpreter stage effectively determines the document product content and the nature of the program elements that propagate through to the document product.

In the event that it is desired to reprocess the document product on the basis of additional or changed variable data then at step 308 the document product is reprocessed as described in more detail below with regard to the specific examples. It will be appreciated that these examples are merely for the purposes of explanation and that the re-processing step can be applied in any appropriate context or implementation.

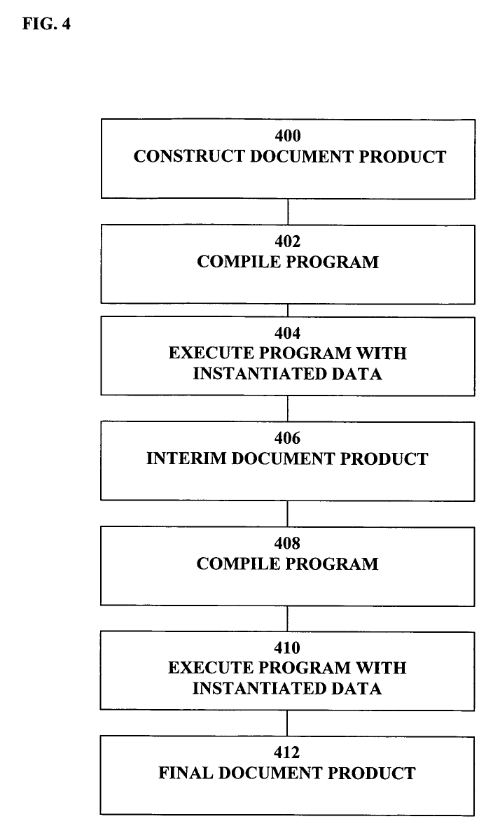

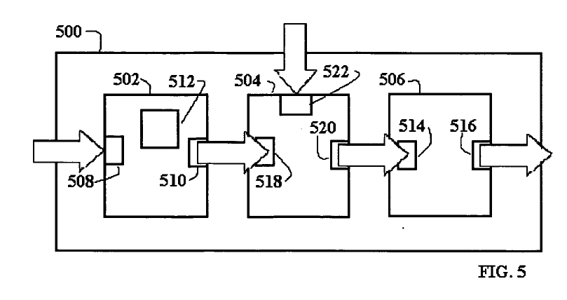

Referring to FIG. 4 it can be seen that the method described herein can be applied in the case where variable data is only partially instantiated. As discussed above, for example, where name data is available but not image data in the identity card scheme of FIG. 2, then an interim identity card with name data only can be created as desired. In another example, in the case of a monthly report sent to multiple recipients the document, referring to listing 2, will include static data such as the data relating to the entity providing the report, static structure and presentation information. In addition the document requires binding with variable data including monthly reports data and recipient data.

The document further comprises program elements determining how the structure and presentation will be implemented dependent on the data. Once the document product is constructed at step 400 then at step 402 the product is compiled into a program as described above. At step 404 the program is executed by an interpreter on the basis of the instantiated variable data. In the case, for example, where the monthly data has been instantiated but recipient data has not yet been found then it may nonetheless be desirable to view the document product arising from the available data. Accordingly at the execution stage the instantiated variable data is bound to provide an interim document product at step 406. If it is desirable to subsequently create a final document product then as the interim document product once again comprises a document including program elements, it is simply compiled once again including the propagated program fragments at step 408 and the program is executed in the context of the fully instantiated data at step 410 providing a final document product at step 412.

It will be seen that the ability to re-process the document product based on additional variable data provides additional flexibility. For example in an alternative configuration, where data in a common category or space is updated incrementally, the approach described may be adopted to allow viewing of the partially instantiated data in that context as well. For example in the case of a medical record where additional information is added over time, it is possible to produce an interim document product showing a medical record during compilation of the medical data to show the current status of the record, and simply re-process the interim document product at a later stage to incorporate additional data as it is instantiated, altered or removed.

It will be appreciated that the entities involved in implementing the method described herein can be selected as appropriate as will be familiar to the skilled reader and without requiring detailed description here. In particular any compiler and interpreter configured to compile/interpret in the relevant machine readable language can be adopted. The document and program can be expressed in any appropriate language for example xml and implemented appropriately for example using extensible style sheet language—transformations (xslt).

For example the method can be implemented by a processor 500 of the type shown in FIG. 5 comprising any appropriate machine capable of reading/processing the documents in the manner described above, such as a PC.

The processor includes a compiler 502, an interpreter 504, and a rendering engine 506. The compiler 502 includes a publishable document input 508 and an executable program output 510 together with an identifier component 512. The interpreter 504 includes an executable program input 518, a variable data input 522 and a document product output 520. The rendering engine 506 includes a document product input 514 and an output 516 for providing a representation of the document product.

It will be seen, therefore, that a publishable document received at the compiler 502 is compiled as described above and output elements identified at the identifying component 512. An executable program is output to the interpreter 504 which also receives variable data at variable data input 522 and generates a document product. In order to obtain a representation of the document contents the document product can be passed to the rendering engine 506 and rendered (in conjunction with appropriate physical hardware such as a printer) to provide a representation, for example the identity cards shown in FIG. 2 or any other appropriate representation. It will be appreciated that the steps can be carried out in a single pass or that the document can be processed at each stage and stored for later processing as appropriate. It will further be appreciated that a single processor may perform some or all of the functions of the components shown in FIG. 5 which are separated purely for the purposes of clarity.

As a result of the method described herein processing of documents is simplified and in addition manipulation of documents such as combination or merging can be easily realised resulting from maintenance of the logical document structure, accessibility and identifiability of combinators and use of a common representation syntax allowing representation of “programs and data”. Because of the incorporation of program elements into the compiled document generator, a simple interpreter may be implemented which does not itself need to understand the semantic but merely interprets the program provided to it. In particular this ensures that significant flexibility can be built into the document configuration without requiring complex rewriting of the interpreter, irrespective of the complexity or richness of the document.

It is advantageous in publishing variable data documents to be able to view and evaluate a document whose variable data has been only partially instantiated, or a document constant over a large set of final forms in which case an intermediate form or partial template can be generated for subsequent re-use. In particular such documents are bound to and evaluated over partial data in a systematic manner and the resulting partial documents can be reprocessed in an identical manner and by identical tools as more data is bound. Furthermore such documents can be combined rigorously with other documents to produce compound forms, even in conditions of partial evaluation.

In the embodiments described above the program elements are written in a declarative or functional form allowing general transformations of considerable power to be employed with rigorously defined properties such that transformation can be exceptionally powerful, widespread and rigorously robust. However any appropriate programming approach can be adopted. Furthermore the language and syntax adopted for the program elements and the surrounding document allows simple support of the incorporation of program as data in a resulting document product, aiding mechanisms such as continuations in documents and allowing the compiler and interpreter to share a common language reducing the translation steps required. Again, however, it will be appreciated that any appropriate language or syntax can be adopted for the respective elements or components of the document and program.

1. A method of processing a publishable document including an input program element for processing variable data, the method comprising:
compiling the publishable document into a program executable to generate a document product, wherein:
the step of compiling includes the step of identifying, for inclusion in the program, output program elements required to process variable data.

2. A method as claimed in claim 1 further comprising the step of including in the program identified output program elements.

3. A method as claimed in claim 2 in which output program elements are constructed during the compilation step from the input program elements.

4. A method as claimed in claim 3 in which output program elements are constructed, during the compilation step, conditional on variable data.

5. A method as claimed in claim 1 further comprising the step of executing the program and processing the variable data to generate a document product.

6. A method as claimed in claim 5 in which the document product comprises an intermediate document including intermediate program elements, the method further comprising the steps of compiling the intermediate document product into a program executable to generate a final or further intermediate document product and executing the program to process variable data to generate a final or further intermediate document product.

7. A method as claimed in claim 5 further comprising incorporating ancillary information into the document product.

8. A method as claimed in claim 7 in which the ancillary information comprises audit trail information.

9. A method as claimed in claim 7 in which the ancillary information is included by one of static introduction into the document product or inclusion as an output program element.

10. A method as claimed in claim 1 in which the publishable document further comprises at least one of data, structure and presentation elements.

11. A method as claimed in claim 1 in which the program elements comprise functional program elements.

12. A computer readable medium containing instructions arranged to operate a processor to implement the method of claim 1.

13. An apparatus for processing a publishable document comprising a processor configured to operate under instructions contained in a computer readable medium to implement the method of claim 1.

14. An apparatus for processing a publishable document including an input program element for processing variable data, the apparatus comprising:
a compiler having a publishable document input and a program output and arranged to compile a publishable document received at the input into a program at the output executable to generate a document product, wherein:
the compiler includes an identifier component arranged to identify, for inclusion in the program, output program elements required to process variable data.

15. An apparatus as claimed in claim 14 further comprising an interpreter including a program input, a variable data input and a document product output in which the interpreter is arranged to receive an executable program and variable data at respective inputs, execute the program dependent on the variable data and generate a document product at the output.
